(19) United States
(12) Patent Application Publication
(10) Pub. No.: US 2006/0015864 A1
(43) Pub. Date: Jan. 19, 2006

(54) System and method for downloading ROM image to wireless terminal

(75) Inventor: Seong Cheol Kang, Osan-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/009,068

(22) Filed: Dec. 13, 2004

(30) Foreign Application Priority Data
Jul. 15, 2004 (KR) 55085/2004

(51) Int. Cl. G06F 9/44

(52) U.S. Cl. 717/173; 717/178

(57) ABSTRACT

Embodiments of a system and methods can download a ROM image to a wireless terminal. The system can include a host system for providing the ROM image and at least one wireless terminal for downloading the ROM image provided from the host system. The host system can include a wireless LAN AP (Access point) device for transmitting the ROM image through a wireless LAN network. The wireless terminal can include a wireless LAN device for connection with the wireless LAN AP device of the host system by the wireless LAN network to download the ROM image stored in the host system.

### BACKGROUND OF THE INVENTION

1. Field of the Invention

The present invention relates to a system and method for downloading a ROM image, and more particularly, to a system and method for downloading a ROM image to a wireless terminal using a wireless LAN network.

2. Background of the Related Art

With the development of communications technologies, research on wireless terminals enabling a data communication using a wireless network has been actively performed. In particular, a personal data assistant (PDA) is a kind of portable computer. The PDA is a portable wireless terminal that permits a reception of a document file made by a computer of a home or an office and a continuous processing of the received document file. The PDA also enables a private information management or a schedule management such as an electronic diary.

Since the PDA has advantages in that its display window size is larger than that of a cellular phone but is smaller than that of a notebook computer, it can store data having much more capacity than that of the cellular phone. Also, since the PDA is convenient to carry compared with the notebook computer, it is in the limelight as a next generation terminal.

In the wireless terminal such as the PDA, operating system (OS), asset data, boodoader program and the like for a variety of functions of the wireless terminal are stored in a format of a ROM image. The ROM image is stored in a flash memory of the wireless terminal. Since the ROM image stored in the flash memory is recorded or deleted by a selected program, the stored data is kept in spite of powering off the wireless terminal.

The functions and specifications of such wireless terminals are being rapidly changed because of the development of technology. Accordingly, when new wireless terminals having advanced functions are released in the market, users want to use the functions of the new wireless terminals.

However, since exchanging the old terminals whenever the new terminals are developed is expensive and requires many related costs, it is more general for most of users to update their wireless terminals. In the related art, to update the ROM image of the wireless terminal, the wireless terminal is connected with the original company's host system (generally, PC system) through a wire to download a new ROM image.

As described above, the related art wireless terminals have various disadvantages. For example, in order for a user to download the ROM image of the wireless terminal, the wireless terminal has to be directly connected to a specific host system through a wire. Further, when multiple wireless terminals are connected to one host system to individually download a ROM image from the host system at the same time, each of these terminals must be provided with a wiring LAN card and a network cable, which causes inconvenience or increased costs to the wireless terminal or increased cost/complexity to the host system.

The above references are incorporated by reference herein where appropriate for appropriate teachings of additional or alternative details, features and/or technical background.

### SUMMARY OF THE INVENTION

An object of the invention is to solve at least the above problems and/or disadvantages or to provide at least the advantages described hereinafter.

Another object of the invention is to provide a system and method for downloading a ROM image to a wireless terminal that substantially obviates one or more problems caused by limitations and disadvantages of the related art.

Another object of the invention is to provide a system and method for downloading a ROM image to a wireless terminal, in which a wireless LAN network is used to download the ROM image to eliminate a wire for access between the wireless terminal and the host system.

Another object of the invention is to provide a system and method for downloading a ROM image to a wireless terminal using a wireless LAN network to enable downloading the ROM image to several wireless terminals at the same time.

Another object of the invention is to provide a system and method for downloading a ROM image to a PDA wireless terminal.

Another object of the invention is to provide a system and method for downloading a ROM image to a wireless terminal using a wireless LAN network to decrease loading time or wireless terminal costs.

To achieve at least the above objects and other advantages in a whole or in part and in accordance with the purpose of the invention, as embodied and broadly described herein, there is provided a system for downloading a ROM image to a wireless terminal, the system including a host system configured to provide the ROM image, wherein the host system includes a wireless LAN AP (Access point) device configured to transmit the ROM image through a wireless LAN network, and the wireless terminal configured to download the ROM image provided from the host system that includes a wireless LAN device, wherein the wireless LAN device is coupled to the wireless LAN AP device of the host system by the wireless LAN network to download the ROM image stored in the host system.

To further achieve at least the above objects in a whole or in part, and in accordance with one aspect of the present invention, there is provided a method for downloading a ROM image to a wireless terminal, the method including selecting a ROM image download mode at a wireless terminal, performing a security authentication procedure of a wireless LAN network for a wireless network/data transmission path formation between the wireless terminal and a host system providing the wireless terminal with the ROM image, forming the wireless network and the data transmission path between the wireless terminal and a host system providing the wireless terminal with the ROM image, receiving a file data of the ROM image from the host system at the wireless terminal and storing the ROM image in a first memory space and replacing a current ROM image stored in a flash memory of the wireless memory with the ROM image stored in the first memory space.

To further achieve at least the above objects in a whole or in part, and in accordance with one aspect of the present invention, there is provided a method for downloading a ROM image to a PDA wireless terminal, the method including selecting a ROM image download mode at a PDA wireless terminal, performing a security authentication procedure of a wireless LAN network for a wireless network/data transmission path formation between the PDA wireless terminal and a host system providing the PDA wireless terminal with the ROM image, forming the wireless network and the data transmission path between the PDA wireless terminal and the host system providing the PDA wireless terminal with the ROM image, receiving a file data of the ROM image from the host system at the wireless terminal and storing the ROM image in a first memory space and replacing a current ROM image stored in a flash memory of the wireless memory with the ROM image stored in the first memory space, wherein the ROM image to be downloaded to the PDA wireless terminal is selected according to a language, an application program or a version from among a plurality of corresponding ROM images.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a preferred embodiment of a system for downloading a ROM image according to the present invention;

FIG. 2 is a flow diagram illustrating a method for downloading a ROM image to a wireless terminal according to a preferred embodiment of the present invention;

FIG. 3 is a diagram that illustrates an exemplary structure of an ID data package transmitted to a host system in a wireless terminal; and

FIG. 4 is a flow diagram illustrating a method for downloading a ROM image to a wireless terminal according to another preferred embodiment of the present invention.

### DETAILED DESCRIPTION OF PREFERRED EMBODIMENTS

Reference will now be made in detail to embodiments of the present invention, examples of which are illustrated in the accompanying drawings.

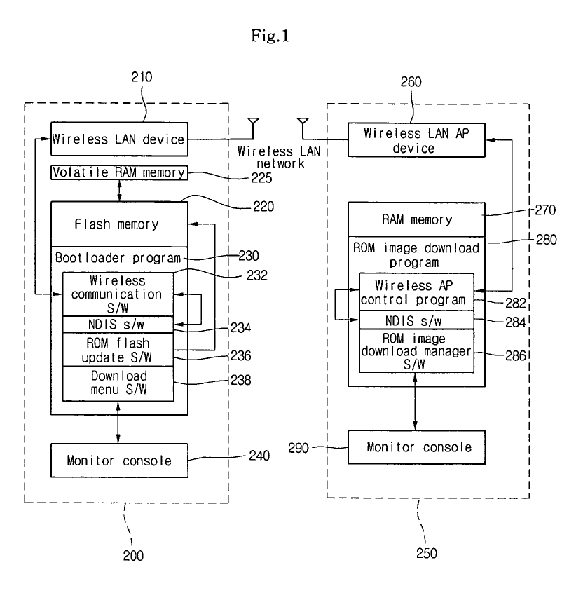

FIG. 1 is a block diagram illustrating an embodiment of a system for downloading a ROM image according to the present invention. In downloading a new version ROM image to update an old ROM image of a wireless terminal, embodiments of the invention can use a wireless local area network (LAN) to get rid of a wiring LAN card and a wiring cable for the connection between a wireless terminal (e.g., wireless terminal 200) and a host system (e.g., host system 250). Further, in embodiments of the invention, a host system can download a ROM image to a plurality of wireless terminals at the same time.

A wireless terminal 200 can be exemplified by a personal data assistant (PDA). However, the present invention is not intended to be so limited. As shown in the embodiment of FIG. 1, in the ROM image downloading system, the wireless terminal 200 can include a wireless LAN device 210 such as a compact flash wireless LAN card, which is connected to a wireless LAN access point (AP) device 260 of a host system 250 by a wireless LAN network. According to embodiments of the invention, it is unnecessary to connect or couple the wireless terminal with the host system through a wiring cable, unlike in the related art.

As shown in FIG. 1, the wireless LAN AP device 260 of the host system 250 can be controlled by a wireless AP control program 282 provided in a RAM memory 270 of the host system 250. Also, since the wireless terminal 200 and the host system 250 are coupled by the wireless LAN network, serial ports and a serial interface of related art systems would be unnecessary.

A user can confirm a ROM image downloading request, a progressive circumstance of a ROM image downloading, etc., to the host system 250 through a monitor console 240 in the wireless terminal 250. Also, the user can confirm progressive status of downloading of a plurality of wireless terminals that each download the ROM image through the host system 250, using a monitor console 290 of the host system 250.

For example, according to an embodiment of the invention, the plurality of wireless terminals can concurrently download the ROM image through the host system 250. Further, the user can confirm such a downloading through the monitor console 290 of the host system 250.

The downloaded ROM image can be stored in a flash memory 220 provided in each of the wireless terminals 200. If necessary, the ROM image may be stored in a volatile RAM memory 225.

The flash memory 220 can store a boodoader program 230. The ROM image can be stored by a ‘ROM flash update S/W (software)’ 236 of the bootloader program 230.

Also, in an embodiment of the invention, the wireless terminal 200 can be connected to the host system 250 via a predetermined security procedure such as a ‘wireless communication S/W’ 232 of the bootloader program 230. After the connection through such procedures, the wireless terminal 200 can download a new ROM image from the host system 250.

Further, a ‘network device interface system (NDIS) S/W’ 234 of the bootloader program 230 can process network data, and thereby a networking between the wireless terminal 200 and the host system 250 can be performed. The RAM memory 270 of the host system 250 is preferably provided with an NDIS S/W 284.

A ‘download menu S/W’ 238 of the bootloader program 230 can display a menu to allow a user to select whether to download the ROM image through the monitor console 240.

Also, the RAM memory 270 of the host system 250 can be provided with a ROM image download program 280, which includes a ‘wireless AP control program’ 282 for controlling the wireless LAN AP device 260, and the ‘NDIS S/W’ 284. The ROM image download program 280 can include a ‘ROM image download manager S/W’ 286. The ‘ROM image download manager S/W’ 286 can control the monitor console 290 of the host system to confirm progressive status and the like of downloading of the plurality of wireless terminals 200 through the monitor console 290.

Generally, ROM images are set in a PDA or cell phone in the factory during manufacture and updates are completed only by the original company. However, cell phones do not generally have wireless LANs and personal computers do not use ROM images.

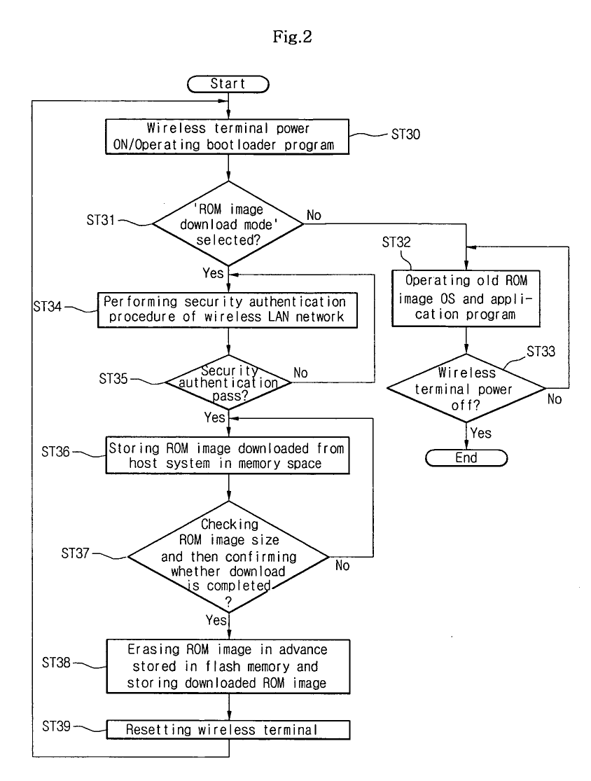

FIG. 2 is a flow diagram illustrating a method for downloading a ROM image to a wireless terminal according to an embodiment of the present invention. The method for downloading a ROM image to a wireless terminal according to the embodiment shown in FIG. 2 can be applied to and will be described using the system shown in FIG. 1. However, the present invention is not intended to be so limited.

After a process starts as shown in FIG. 2, power of the wireless terminal can be turned on to start the bootloader program 230 of the wireless terminal 200. (block ST30) The bootloader program 230 can be executed before an operating system (OS) of the wireless terminal 200 starts, and can perform a similar role to BIOS of a general computer.

Next, as the bootloader program starts, a user can select the ‘ROM image download mode,’ for example, on the menu displayed on a display part of the wireless terminal 200, (e.g.,) the monitor console 240 of the wireless terminal 200. (block ST31)

In one example, when the bootloader program 230 starts, the monitor console 240 can display the menu of ‘normal operation mode’ and ‘ROM image download mode’ for the user. When the user selects the menu of ‘ROM image download mode’, a flag (e.g., signal) for the selected ‘ROM image download mode’ can be set to 1 (e.g., a prescribed value), and then a procedure for executing the ROM image download can be performed.

As shown in FIG. 2, the ROM image download means to download a new or updated version image of the ROM image. The updated version of the ROM image can be stored in the flash memory 220 of the wireless terminal as described above.

Alternatively, the ‘ROM image download mode’ may be performed by pushing a combination of buttons of the wireless terminal 200, (e.g., ‘button#1+#4+reset’) instead of displaying the menu on the monitor console 240 and selecting the ‘ROM image download mode’. At this time, a flag (e.g., signal) for the ‘ROM image download’ can be set to 1 (e.g., a prescribed value) such that the ‘ROM image download mode’ instead of the ‘normal operation mode’ can be performed. However, the present invention is not intended to be so limited by the above examples and descriptions.

When the user does not select the ‘ROM image download mode’ (block ST31), the wireless terminal can operate in the ‘normal operation mode’. Then, an OS (operating system) using a previously prepared ROM image, and an application program can operate (block ST32) preferably continuously until the power of the wireless terminal is turned off. (block ST33)

Alternatively, when the user selects the ‘ROM image download mode’, the wireless terminal 200 can perform a procedure for downloading a new ROM image.

As shown in FIG. 1, the new ROM image to be updated to the wireless terminal can be stored in the RAM memory 270 of the host system 250. Accordingly, to download the new ROM image from the host system 250, a data transmission path should be formed between the wireless terminal 200 and the host system 250.

In downloading a new version ROM for the wireless terminal, one aspect of embodiments of the invention can be characterized by removing a wiring LAN card and a wiring cable for the connection between the wireless terminal 200 and a host system 250, and enabling downloading a ROM image to a plurality of wireless terminals 200 at the same time. Embodiments of the invention can use a wireless LAN network to download an updated version of a ROM for the wireless terminal.

To accomplish the above characteristic, the wireless terminal 200 should be provided with the wireless LAN device 210 and the host system 250 should be provided with the wireless LAN AP device 260. To initiate data protocol between the wireless terminal and the AP of the host system, a security authentication procedure of the wireless LAN network for discriminating a subject wireless terminal from another wireless terminal should be precedingly performed. (block ST34)

For example, the selected wireless terminal 200 that tries to connect to the host system 250 to download a ROM image can create SSID and security key data of the host system 250 and transmit the created SSID and security key data to the host system 250. The wireless LAN AP device 260 can confirm whether the transmitted SSID and security key data accord with stored SSID and security key data. The wireless LAN AP device 260 can start data transmission between the wireless terminal 200 and the ROM image download program 280 of the host system 250 when the transmitted SSID and security key data accord with stored SSID and security key data. (block ST35)

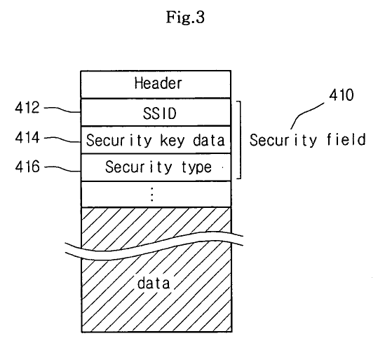

FIG. 3 is a diagram that illustrates a structure of an exemplary ID data package transmitted to a host system in a wireless terminal. As shown in FIG. 3, a security field 410 of the ID data package can be provided with an SSID 412, a security key data 414, a security type 416 and the like. The data transmission path for downloading the ROM image can be formed between the host system and the wireless terminal only when data provided in the security field 410 accord with data requested by the host system 250.

In one example, when the SSID 412 of the wireless LAN AP device 260 of the host system 250 is set as ‘E1 PDA MFG AP’, the wireless terminal 200 can create the ID data package with respect to the SSID 412 in the ‘wireless communication S/W’ 232 of the wireless terminal 200 and transmit to the wireless LAN AP device 260 of the host system 250. Accordingly, as the host system 250 requests the security key data 414, the wireless communication S/W 232 of the wireless terminal 200 can create a corresponding key data (e.g., abcd123456) and transmit the created key data to the host system 250, so that the wireless LAN data protocol between the wireless LAN AP device 260 of the host system 250 and the wireless LAN device 210 of the wireless terminal is initiated. It is noted that the package data structure for the data protocol can be the same as that in a related art wired LAN but the frame data structure of embodiments of the invention for transmission environment (e.g., RF channel selection, RF signal operation, etc.) enabling wireless data transmission through the wireless LAN network is different.

Thus, if the data protocol between the wireless terminal 200 and the host system 250 is initiated, the ‘wireless communication S/W’ 232 provided in the flash memory 220 of the wireless terminal 200 can receive a new ROM image file data from the host system 250 through the wireless LAN AP device 260 and store the new ROM image file data in a memory space of the wireless terminal 200, for example, by a size of the file data. Herein, it is noted that the memory space can be the volatile RAM 225 not the flash memory. Also, if necessary, it is possible to store the new ROM image data in a nonvolatile flash memory. (block ST36)

Thereafter, the size of the downloaded new ROM image data can be checked, and it can be confirmed whether all the ROM image data are downloaded. (block ST37) When it is confirmed that all the ROM image data are downloaded, the ‘ROM flash update S/W’ 236 can control storing the new ROM image in the wireless terminal 200. For example, the ‘ROM flash update S/W’ 236 can erase the old ROM image stored in the flash memory, and store the new ROM image stored in the volatile RAM 225 in the flash memory 220. (block ST38)

Thus, the ROM image of the wireless terminal can be updated. Then, the wireless terminal can be rebooted for normal operations.

Next, for example, the flag (e.g., signal) set to 1 can be changed into 0 such that the ‘normal operation mode’ not the ‘ROM image download mode’ is performed when the wireless terminal is rebooted. Thus, the wireless terminal is reset. (block ST39)

In this case, resetting the wireless terminal can be performed by software transition to a reset code, or by allowing a software to generate a signal in a hardware reset pin or the like. However, the present invention is not intended to be so limited.

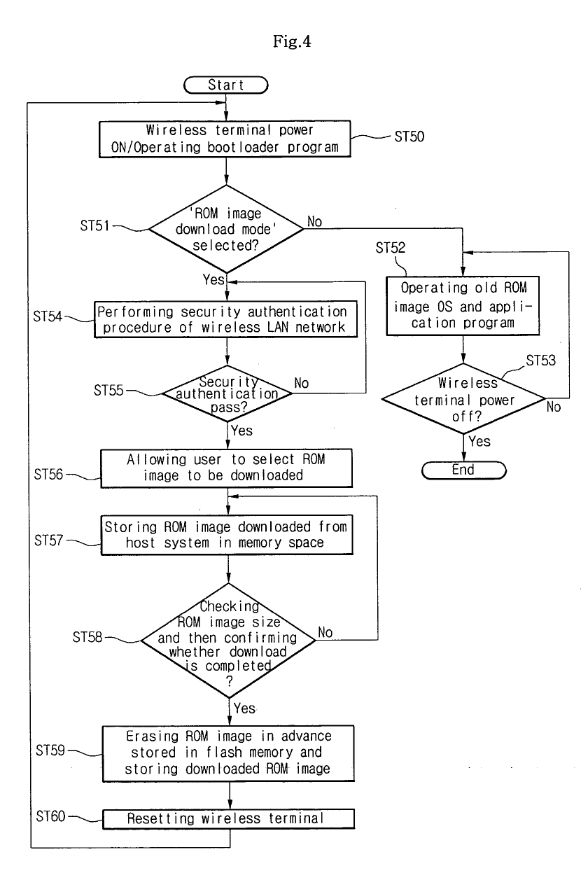

FIG. 4 is a flow diagram illustrating a method for downloading a ROM image to a wireless terminal according to another embodiment of the present invention. The method for downloading a ROM image to a wireless terminal shown in FIG. 4 can be applied to and will be described using the system shown in FIG. 1. However, the present invention is not intended to be so limited.

Compared with the embodiment of FIG. 2, the embodiment of FIG. 4 is similar however the embodiment of FIG. 4 further can include allowing a user to select the ROM image to be downloaded (block ST56) after passing through the security authentication procedure (block ST55) to initiate the data protocol between the wireless terminal and the host system. Accordingly, a detailed description of portions similar to the embodiment of FIG. 2 will be omitted here.

One wireless terminal (e.g., wireless terminal 200) generally can include a plurality of ROM images. Accordingly, there may exist one or more ROM image data that does not need to be updated among the ROM image data provided by the host system.

The embodiment described in FIG. 4 can allow a user to selectively download only the ROM image data that a user selects and wishes to update. Thus, the embodiment of FIG. 4 can avoid downloading an unnecessary ROM image(s).

Further, the embodiment of FIG. 4 can make it possible to reduce time spent in downloading the ROM image. In addition, the memory capacity can be effectively managed.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of a wireless terminal, a wireless system including a host system and a wireless LAN network and method for downloading a ROM image to a wireless terminal according to the invention have various advantages. Embodiments of the present invention can be used to make it easier to download (e.g., selectively) the ROM image, reduce costs of a wireless terminal, provide convenience getting rid of a wire for connection between the wireless terminal and the host system, or enable downloading the ROM image to several wireless terminals at one time to enhance productivity.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A system for downloading a ROM image to a wireless terminal, the system comprising:
a host system configured to provide the ROM image, wherein the host system includes a wireless LAN AP (Access point) device configured to transmit the ROM image through a wireless LAN network, and
the wireless terminal configured to download the ROM image provided from the host system that includes a wireless LAN device, wherein the wireless LAN device is coupled to the wireless LAN AP device of the host system by the wireless LAN network to download the ROM image stored in the host system.

2. The system according to claim 1, wherein the wireless terminal is a PDA (Personal data assistant).

3. The system according to claim 2, wherein the downloaded ROM image is stored in a flash memory disposed in the wireless terminal.

4. The system according to claim 3, wherein the flash memory is provided with a bootloader program, and the downloaded ROM image is stored by a ROM flash update software in the bootloader program.

5. The system according to claim 4, wherein the ROM flash update software erases a current ROM image stored in the flash memory and stores the downloaded ROM image.

6. The system according to claim 5, wherein the current ROM image was set during manufacture of the wireless terminal.

7. The system according to claim 4, wherein a wireless network path between the wireless terminal and the host system is formed by performing a predetermined security procedure using a wireless communication protocol in the bootloader program.

8. The system according to claim 1, wherein the wireless LAN AP device of the host system is controlled by a wireless AP control program provided in a RAM memory of the host system.

9. The system according to claim 1, wherein the wireless terminal further comprises a monitor console for the wireless terminal and performs a ROM image download request and a ROM image download progress status confirmation through the monitor console, and wherein the host system further comprises a monitor console for the host system and confirms download progress status of wireless terminals that download the ROM image from the host system through the monitor console.

10. The system according to claim 1, wherein the host system concurrently downloads the ROM image to a plurality of wireless terminals.

11. A method for downloading a ROM image to a wireless terminal, the method comprising:
selecting a ROM image download mode at a wireless terminal;
performing a security authentication procedure of a wireless LAN network for a wireless network/data transmission path formation between the wireless terminal and a host system providing the wireless terminal with the ROM image;
forming the wireless network and the data transmission path between the wireless terminal and the host system providing the wireless terminal with the ROM image;
receiving a file data of the ROM image from the host system at the wireless terminal and storing the ROM image in a first memory space; and
replacing a current ROM image stored in a flash memory of the wireless memory with the ROM image stored in the first memory space.

12. The method according to claim 11, wherein the wireless terminal is a PDA (Personal data assistant).

13. The method according to claim 11, wherein the first memory space is a volatile RAM or additional flash memory.

14. The method according to claim 11, wherein the flash memory is nonvolatile, and the ROM image is greater than 50 Mbytes.

15. The method according to claim 11, comprising:
resetting the wireless terminal when the ROM image download is completed, wherein the resetting comprises,
rebooting the wireless terminal, and
performing an operation mode at the wireless terminal.

16. The method according to claim 11, wherein the selecting a ROM image download mode comprises displaying a selection menu including the normal operation mode and the ROM image download mode to a user, wherein the user selects the ROM image download mode.

17. The method according to claim 11, wherein the ROM image download mode is selected by pushing a combination of buttons of the wireless terminal.

18. The method according to claim 11, wherein the performing the security authentication procedure of the wireless LAN network comprises:
creating SSID and security key data of the host system at the wireless terminal and transmitting the created SSID and security key data to the host system; and
confirming the transmitted SSID and security key data comply with stored SSID and security key data at the host system, and initiating a data protocol between the wireless terminal and an AP of the host system when the transmitted SSID and security key data comply with stored SSID and security key data.

19. The method according to claim 18, wherein the creating comprises setting the security key data according to a SSID of a predetermined AP stored in the ROM flash update software.

20. The method according to claim 18, wherein the wireless terminal selects the host system using the predetermined SSID.

21. The method according to claim 11, wherein the wireless terminal and the host system have a wireless LAN card and a wireless LAN AP device, respectively, to perform a ROM image download through a wireless LAN network.

22. The method according to claim 11, wherein after the performing the security authentication procedure of the wireless LAN network, further comprising selecting a prescribed ROM image to be downloaded to the wireless terminal by a user.

23. The method according to claim 22, wherein the prescribed ROM image to be downloaded to the wireless terminal is selected according to a language, an application program or a version by the user.

24. The method according to claim 23, wherein the prescribed ROM image is at least two ROM images selected from among a plurality of corresponding ROM images.

25. The method according to claim 11, comprising resetting the wireless terminal.

26. A method for downloading a ROM image to a PDA wireless terminal, the method comprising:
selecting a ROM image download mode at a PDA wireless terminal;
performing a security authentication procedure of a wireless LAN network for a wireless network/data transmission path formation between the PDA wireless terminal and a host system providing the PDA wireless terminal with the ROM image;
forming the wireless network and the data transmission path between the PDA wireless terminal and the host system providing the PDA wireless terminal with the ROM image;
receiving a file data of the ROM image from the host system at the wireless terminal and storing the ROM image in a first memory space; and
replacing a current ROM image stored in a flash memory of the wireless memory with the ROM image stored in the first memory space, wherein the ROM image to be downloaded to the PDA wireless terminal is selected according to a language, an application program or a version from among a plurality of corresponding ROM images.
